(19) United States
(12) Patent Application Publication
(10) Pub. No.: US 2025/0322468 A1
(43) Pub. Date: Oct. 16, 2025

(54) SYSTEMS AND METHODS FOR TRANSMITTING INFORMATION

(71) Applicant: QUARTER, INC., Niwot, CO (US)

(72) Inventor: Michael DIESCH, Niwot, CO (US)

(73) Assignee: QUARTER, INC., Niwot, CO (US)

(21) Appl. No.: 19/252,689

(22) Filed: Jun. 27, 2025

Related U.S. Application Data
(63) Continuation-in-part of application No. 18/503,881, filed on Nov. 7, 2023, now Pat. No. 12,388,776.
Application No. 18/503,881 is a continuation-in-part of application No. 17/806,677, filed on Jun. 13, 2022.
Application No. 17/806,677 is a continuation-in-part of application No. 17/121,510, filed on Dec. 14, 2020, now Pat. No. 11,582,324.
Application No. 18/503,881 is a continuation-in-part of application No. 18/046,689, filed on Oct. 14, 2022.
Application No. 18/046,689 is a continuation-in-part of application No. 17/121,510, filed on Dec. 14, 2020, now Pat. No. 11,582,324.
(60) Provisional application No. 62/948,136, filed on Dec. 13, 2019.
(60) Provisional application No. 63/209,858, filed on Jun. 11, 2021.
(60) Provisional application No. 63/382,995, filed on Nov. 9, 2022.
(60) Provisional application No. 63/578,514, filed on Aug. 24, 2023.
(60) Provisional application No. 63/665,723, filed on Jun. 28, 2024.

(51) Int. Cl. G06Q 50/163; G06Q 40/03

(52) U.S. Cl. CPC G06Q 50/163; G06Q 40/03

(57) ABSTRACT

The disclosed system and method can manage real-time transactions using a blockchain ledger. A processor can create a fractionalized risk pool for a property, comprising asset tokens and an occupancy token. The processor can receive title information and can update the blockchain ledger with this information, a timestamp, and/or a property valuation. Upon receiving a transaction from a credit card network and/or issuing bank, the processor can determine a user's real-time equity.

### CROSS REFERENCE TO RELATED APPLICATION

This application claims the benefit of priority to U.S. Provisional Patent Application No. 63/665,723 entitled “SYSTEM AND METHOD FOR MANAGING TRANSACTIONS USING BLOCKCHAIN,” filed Jun. 28, 2024. This application is also a Continuation-In-Part of U.S. patent application Ser. No. 18/503,881 entitled “METHODS AND SYSTEMS FOR DIFFERENTIATING INFORMATION,” filed Nov. 7, 2023, which claims the benefit of U.S. Provisional Patent Application No. 63/382,995 entitled “METHODS AND SYSTEMS FOR TRANSMITTING,” filed Nov. 9, 2022, and U.S. Provisional Application No. 63/578,514 entitled “METHODS AND SYSTEMS FOR DIFFERENTIATING INFORMATION,” filed Aug. 24, 2023. Application Ser. No. 18/503,881 is also a Continuation-In-Part of U.S. patent application Ser. No. 17/806,677 entitled “METHODS AND SYSTEMS FOR TRANSMITTING INFORMATION,” filed Jun. 13, 2022, which claims the benefit of U.S. Provisional Application No. 63/209,858 entitled “METHODS AND SYSTEMS FOR TRANSMITTING INFORMATION,” filed Jun. 11, 2021. U.S. patent application Ser. No. 17/806,677 is also a Continuation-In-Part of U.S. patent application Ser. No. 17/121,510 entitled “METHODS AND SYSTEMS FOR TRANSMITTING INFORMATION,” filed Dec. 14, 2020 (now U.S. Pat. No. 11,582,324 issued Feb. 14, 2023), which claims the benefit of U.S. Provisional Patent Application No. 62/948,136, entitled “METHODS AND SYSTEMS FOR FACILITATING REAL ESTATE TRANSACTIONS,” filed Dec. 13, 2019. U.S. patent application Ser. No. 18/503,881 is also a Continuation-In-Part of U.S. patent application Ser. No. 18/046,689 entitled “METHODS AND SYSTEMS FOR TRANSMITTING INFORMATION,” filed Oct. 14, 2022, which is a Continuation-In-Part of U.S. patent application Ser. No. 17/121,510 entitled “METHODS AND SYSTEMS FOR TRANSMITTING INFORMATION,” filed Dec. 14, 2020 (now U.S. Pat. No. 11,582,324 issued Feb. 14, 2023) which claims the benefit of U.S. Provisional Patent Application No. 62/948,136, entitled “METHODS AND SYSTEMS FOR FACILITATING REAL ESTATE TRANSACTIONS,” filed Dec. 13, 2019. All of the applications and patents listed above are hereby incorporated by reference in their entireties for all purposes.

### BRIEF DESCRIPTION OF THE FIGURES

The following figures are provided for example purposes only, and are not intended as a limitation on the scope of the present disclosure.

FIG. 1 illustrates an initial boarding process onto a home equity network, according to aspects of the present disclosure.

FIG. 2 depicts an alternative boarding process for managing property data and transactions, according to aspects of the present disclosure.

FIG. 3 shows a title insurance policy recordation process, according to aspects of the present disclosure.

FIG. 4 presents an alternative digital ledger recordation process, according to aspects of the present disclosure.

FIG. 5 illustrates a transaction management system, according to aspects of the present disclosure.

FIG. 6 depicts a title tracking process, according to aspects of the present disclosure.

FIG. 7 shows a valuation monitoring process, according to aspects of the present disclosure.

FIG. 8 presents a fractional transaction management system, according to aspects of the present disclosure.

FIG. 9 illustrates a transaction approval system, according to aspects of the present disclosure.

FIG. 10 depicts an investor transaction system for managing fractional real estate transactions, according to aspects of the present disclosure.

FIG. 11 shows a block diagram of a computer system architecture, according to aspects of the present disclosure.

### DETAILED DESCRIPTION OF ASPECTS OF THE DISCLOSURE

This disclosure is not limited to the particular systems, devices and methods described, as these may vary. The terminology used in the description is for the purpose of describing the particular versions or embodiments only and is not intended to limit the scope.

As used in this document, the singular forms “a,” “an,” and “the” include plural references unless the context clearly dictates otherwise. Those having skill in the art can also translate from the plural form to the singular as is appropriate to the context and/or application. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices also can “consist essentially of” or “consist of” the various components and steps, and such terminology should be interpreted as defining essentially closed-member groups.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

The term “about,” as used herein, refers to variations in a numerical quantity that can occur, for example, through measuring or handling procedures in the real world; through inadvertent error in these procedures; through differences in the manufacture, source, or purity of compositions or reagents; and the like. Typically, the term “about” as used herein means greater or lesser than the value or range of values stated by 1/10 of the stated values, e.g., ±10%. The term “about” also refers to variations that would be recognized by one skilled in the art as being equivalent so long as such variations do not encompass known values practiced by the prior art. Each value or range of values preceded by the term “about” is also intended to encompass the embodiment of the stated absolute value or range of values. Whether or not modified by the term “about,” quantitative values recited in the present disclosure include equivalents to the recited values, e.g., variations in the numerical quantity of such values that can occur, but would be recognized to be equivalents by a person skilled in the art.

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure can relate to systems and methods for maintaining up-to-date valuations of a user's home equity by leveraging blockchain technology. These valuations, reflecting the current equity value, can serve as security for consumer transactions with merchants and/or can be traded in various marketplaces. The dynamic nature of the system can help the equity value be consistently aligned with real-time market conditions, and can provide a reliable basis for financial activities that depend on the property's equity.

The innovative system described in this disclosure can help the management of real estate transactions. The system can integrate blockchain technology to facilitate fractional ownership and/or can enhance transaction efficiency. The system can use asset tokens, which can be digital representations of ownership rights in physical real estate properties. These asset tokens can define a fractionalized risk pool created for a property, and can allow multiple parties to own and/or trade percentages of the property in a transparent and secure manner.

Asset tokens can be issued on a blockchain ledger, which can serve as an immutable record of all transactions and ownership details. This ledger can be updated in real-time with title information, or property valuations, or transaction data, or any combination thereof, and can help all participants have access to accurate and current information.

Asset tokens can increase market liquidity. By helping to enable fractional ownership, asset tokens can allow for smaller investment increments, and can help make real estate investment accessible to a broader range of investors. This can lead to a more dynamic and fluid market, as asset tokens can be easily bought and/or sold on secondary markets.

Furthermore, the system can help users to leverage their real-time equity, as represented by their asset tokens or tenancy in common (TIC) interests, for various financial activities. For instance, users can transact with merchants using their equity as collateral, and/or they can acquire additional asset tokens through reward systems linked to credit card networks and/or issuing banks. In the event of payment delinquencies, the system can automatically adjust the user's holdings of asset tokens to compensate for the transaction amount.

The system may also utilize Home Price Index (HPI) tokens. HPI tokens can be a digital asset that represent a claim on the aggregate appreciation of all the properties on a platform. HPI tokens can be configured to reflect the collective value increase of the underlying real estate assets and/or can be traded independently of the asset tokens.

HPI tokens may be issued to both asset token holders and/or investors in the platform as a means to participate in the overall appreciation of the property market without directly owning a specific property. The value of HPI tokens can be linked to a Home Price Index, which can track the changes in the value of residential properties on the platform over time. As the market value of the properties increases, so can the value of the HPI tokens, providing a potential return on investment for the holders.

The HPI tokens can be unlocked and distributed to token holders based on predetermined conditions, such as the achievement of specific appreciation thresholds. This mechanism can allow for the realization of gains from property value appreciation in a liquid form, and can enable investors to benefit from real estate market growth even if they do not wish to sell their asset tokens.

The integration of HPI tokens into the transaction management system can add another layer of investment opportunity on the platform. It can allow for a more diversified investment strategy where participants can choose to invest in individual properties through asset tokens and/or in the broader real estate market through HPI tokens. This can attract a wider range of investors and/or can contribute to the liquidity and/or stability of the real estate token market.

By combining the use of asset tokens and HPI tokens, the disclosed system can offer a comprehensive approach to real estate investment on the blockchain, and can provide flexibility, security, and/or the potential for growth to all participants involved.

The system may further incorporate Lifetime Appreciation Tokens (LAT), which can represent a distinct class of digital assets designed to capture long-term value appreciation across the platform's real estate portfolio. LAT tokens may be issued to platform operators, service providers, and/or strategic partners as a form of equity participation in the overall growth and success of the real estate ecosystem. These tokens can provide holders with rights to a portion of the aggregate appreciation generated by all properties managed through the platform over extended time periods.

LAT tokens may work in conjunction with HPI tokens to create a comprehensive appreciation-sharing mechanism. While HPI tokens may focus on shorter-term and/or periodic appreciation distributions based on market movements, LAT tokens may be designed to capture cumulative value creation over the lifetime of the platform's operations. The relationship between LAT and HPI tokens may be structured such that LAT holders may receive distributions when HPI tokens are unlocked, creating a tiered system where different stakeholders participate in property appreciation at different levels and timeframes.

The distribution mechanism for LAT tokens can be tied to the same valuation events that trigger HPI token unlocking. When properties on the platform achieve new high-water marks in valuation, the system can allocate portions of the appreciation to LAT token holders alongside HPI token distributions. This may aid in aligning the interests of platform operators and/or long-term stakeholders with the overall performance of the real estate portfolio, and/or may provide incentives for continued platform development and property value enhancement.

LAT tokens can also serve as a governance mechanism, potentially granting holders voting rights on platform policies, property acquisition strategies, and/or distribution methodologies. The platform may include a stakeholder structure where those with long-term commitments to the platform's success have input into its strategic direction, while also benefiting from the cumulative appreciation generated by the underlying real estate assets over time.

Ownership of a home (e.g., using asset tokens) can be defined in some aspects by a TIC agreement. A tenancy in common (TIC) agreement can be a form of real property ownership where two or more individuals co-own a property in undivided fractional interests that can be of unequal sizes, and which can be freely transferred by each owner. In a TIC agreement, each co-owner, referred to as a tenant in common, can have an individual, divisible right to their share of the property, can be entitled to a proportionate share of the income from the property, or can have responsibility for associated expenses, or any combination thereof. Tenants in common can hold title to the property without any right of survivorship, meaning that upon the death of one tenant, their interest in the property can become part of their estate and/or can be bequeathed to their heirs or designated beneficiaries.

The TIC agreement can outline the rights and obligations of each tenant in common, including the right to sell or encumber their share of the property independently of the other co-owners. It can also detail the process for managing the property and/or resolving disputes. The TIC agreement can be a flexible and customizable legal document that can accommodate various co-ownership scenarios. In certain aspects, the TIC agreement can obligate a resident of the property to maintain records of the status of the property. For example, a resident can be required by the TIC agreement to upload photos of the property. Alternatively, a resident can be required to have the property inspected and/or assessed. These obligations can be required on a schedule basis (e.g., yearly) and/or in response to significant damages and/or improvements to the property.

In some aspects, the TIC interest may be held by a Special Purpose Entity (SPE), which can be an entity created for a specific purpose, such as, but not limited to, to isolate financial risk. The SPE can be structured as a separate legal entity, such as a limited liability company (LLC), a trust, and/or a corporation, and can be specifically designed to hold the TIC interests in the property. The SPE can serve as a vehicle for investment, and can allow multiple investors to pool their resources and/or hold a fractionalized interest in the property through the ownership of asset tokens.

The SPE can manage the TIC interests on behalf of the investors, and can handle administrative tasks such as, but not limited to, the collection of income, payment of expenses, and/or distribution of profits. The SPE can also be responsible for enforcing the terms of the TIC agreement, including maintenance and/or repair obligations, and can act as an intermediary between the tenants in common and/or third parties, such as, but not limited to, property managers and/or service providers.

By holding the TIC interest through an SPE, investors can benefit from limited liability protection, as their personal assets can be shielded from the liabilities associated with the property ownership. Additionally, the SPE can provide a clear and distinct ownership structure that can simplify the management and/or transfer of the TIC interests, such as when utilizing blockchain technology to record and/or track the ownership and/or transactions related to the property.

The asset tokens can represent an economic interest in the entity that holds the TIC interest (e.g., they may not represent the TIC interests directly). While a first investor may sell asset tokens to a second investor resulting in a change of each of their economic interests, which can be correlated to the TIC interests held by the SPE, they may not be transferring TIC interests between themselves. For example, if at a given point in time there may be $100K of TIC interests at the current valuation held by the homeowner and $200K by the SPE ($300K total home value), then there would be a combined value of asset tokens and HPI tokens (based on book value) of $200K. Assuming that there was $150K in asset tokens and $50K in accrued HPI token book value, then the asset tokens can represent economic interests correlating three quarters of the $200K of TIC interests held by the SPE.

In some aspects, the system can incorporate an artificial intelligence (AI) model. This model can do various tasks, such as analyzing analyzes uploaded photos of a property to determine a valuation and/or a change in status of the property. The AI model can utilize machine learning algorithms, including but not limited to convolutional neural networks (CNNs), deep learning networks, random forest algorithms, support vector machines, gradient boosting algorithms, recurrent neural networks (RNNs), long short-term memory (LSTM) networks, transformer models, ensemble learning methods, decision trees, and/or other machine learning algorithms to process and interpret visual data from the uploaded photos. By examining various attributes such as property condition, size, layout, aesthetic appeal, any visible damages, or any visible improvements, or any combination thereof, the AI model can assess the property's current state and/or estimate its market value.

The AI model can be trained on a diverse dataset of property images and/or corresponding valuation data to enhance its accuracy in real-world applications. This training can help the model to recognize patterns and/or features that can be indicative of property value, which can be particularly useful for detecting subtle changes that may not be immediately apparent to the human eye.

For example, upon receiving new photos uploaded by a resident and/or a property manager, the AI model can compare the latest images with previously captured imagery, and/or data derived therefrom, to identify any changes in the property's condition. These changes can include renovations, repairs, or damages, or any combination thereof, that could affect the property's valuation. The AI model may also identify adherence to building codes and/or compliance with improvement plans, which can provide additional insights into the property's regulatory status and/or planned enhancements.

The integration of the AI model into the system can provide a streamlined and/or automated approach to property valuation and status updates, and can reduce the reliance on manual inspections and/or appraisals. This technology can facilitate more frequent and/or precise valuations, and can contribute to the overall efficiency and/or reliability of real estate transactions managed through the blockchain-based system.

Transactions can be performed using Decentralized Finance (DeFi) and/or Traditional Finance (TradFi) lending.

DeFi lending can be a financial service that operates on a blockchain network, and can allow individuals to lend and/or borrow assets without the intermediation of traditional financial institutions. DeFi platforms can utilize smart contracts, which can be self-executing contracts with the terms of the agreement directly written into code. These platforms can offer permissionless services, meaning that anyone with a blockchain wallet can participate without the need for a credit check and/or a third-party intermediary.

DeFi lending protocols can offer over-collateralized loans, where the borrower can provide collateral in the form of cryptocurrency that can exceed the value of the loan. Interest rates can often be determined algorithmically based on supply and/or demand for the assets within the platform. DeFi lending can provide higher yields for lenders and/or more accessible borrowing opportunities for borrowers, albeit potentially with a higher risk due to the volatility of the underlying assets and the potential for smart contract vulnerabilities.

TradFi lending can refer to the system of lending that operates through established financial institutions such as banks, credit unions, or mortgage companies, or any combination thereof. In TradFi, intermediaries can play a central role in the lending process, such as conducting credit assessments, managing risk, or ensuring regulatory compliance, or any combination thereof. Borrowers can be subject to credit checks and/or can be asked to provide collateral and/or a guarantor to secure a loan.

Interest rates in TradFi lending can be influenced by various factors, including the central bank's monetary policy, the borrower's creditworthiness, or the institution's operational costs, or any combination thereof. TradFi institutions can provide a range of lending products, such as mortgages, personal loans, or credit lines, or any combination thereof, with terms and/or conditions that can be defined in legal agreements.

While TradFi lending can be characterized by a higher degree of regulatory oversight and/or consumer protection, it can also involve longer processing times, higher fees, or less flexibility, or any combination thereof, compared to DeFi lending.

The integration of blockchain technology into real estate transactions, such as described in this disclosure, can have the potential to bridge the gap between DeFi and TradFi lending, and/or can offer a novel approach to property ownership and/or investment. By leveraging the transparency, security, or efficiency of blockchain, or any combination thereof, the disclosed system can facilitate new forms of lending that can combine the strengths of both DeFi and TradFi models.

The integration of asset tokens into real estate transactions can help provide a more efficient, accessible, and/or transparent property market. By harnessing the power of blockchain technology, the system outlined in this disclosure can offer a novel approach to property ownership and investment, with asset tokens that can serve as the vehicle for this modern real estate paradigm.

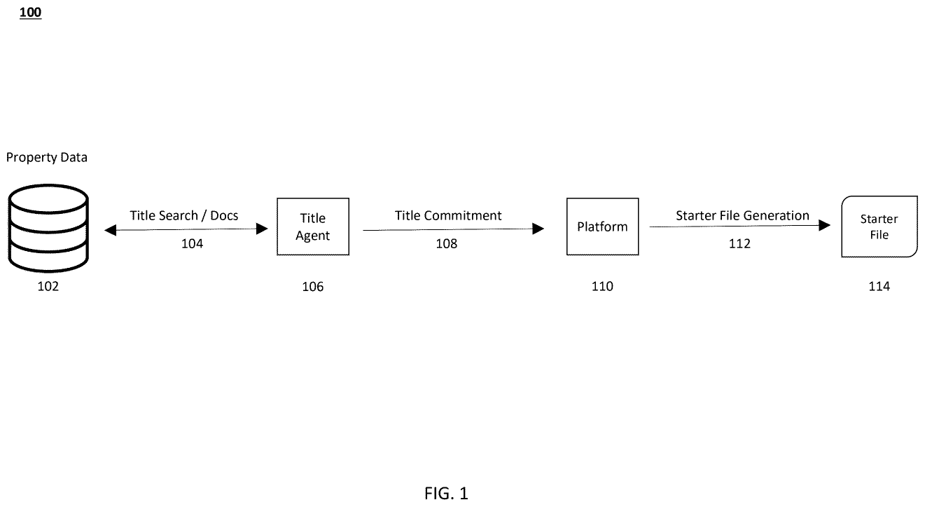

Referring to FIG. 1, in some aspects, a boarding process 100 can be initiated as part of an initial boarding onto a home equity network. This process can involve conducting a title search 104 and/or collecting property documents from one or more databases of property data 102. In some cases, a title search agent 106 can issue an owner's commitment, and/or a title commitment 108, to a platform 110 in preparation for the closing of a house.

A title commitment 108 can be a document issued by a title company after a title search has been completed but before the actual issuance of a title insurance policy. The title commitment can outline the conditions under which a title insurance policy will be issued, listing any defects, liens, and/or encumbrances on the property that can have been discovered during the title search. It can also detail the terms, exceptions, and/or specific requirements that have to be met before a clear title can be transferred. The title commitment can serve as a promise from the title company to issue a title insurance policy to the new owner and/or lender upon the satisfaction of the listed requirements and/or the resolution of any issues identified during the title search.

The platform 110 can collect the title commitment data 108 and search documents to generate a starter file 114 for the house. The starter file 114 can comprise the collected data and/or documents which pertain to the property. In some cases, the starter file 114 can be time-stamped and/or used as a starting point for future property data searches.

In some aspects, the starter file generation 112 can be an automated process that can be triggered by the receipt of the title commitment 108 and/or the search documents. This can enhance the efficiency of the boarding process 100 and/or can reduce the chances of errors and/or omissions in the starter file 114.

In some aspects, the starter file 114 can be updated or modified over time as new property data 102 is collected and/or as changes occur in the status of the property. This can help the starter file 114 remains current and/or accurate, and can facilitate accurate and/or reliable equity valuation in real-time.

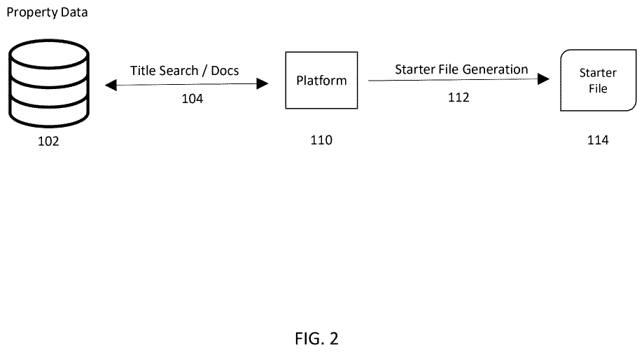

Referring now to FIG. 2, an alternative boarding process 200 for managing property data and/or transactions is depicted. In some aspects, property data 102 can be accessed directly by the platform 110. The platform 110 can perform a title search 104 to collect titles and/or other related documentation. The platform 110 can generate 112 a starter file 114. The starter file 114 can include the collected data and/or documents which pertain to the property at that point in time.

In some aspects, the starter file 114 can be time-stamped and/or used as a starting point for future property data searches. This can provide a comprehensive and up-to-date record of the property, which can be useful for various purposes such as transaction approval, property valuation, and/or equity determination.

In some cases, the starter file 114 can be time-stamped and/or used as a starting point for future property data searches. This can provide a comprehensive and/or up-to-date record of the property, which can be useful for various purposes such as transaction approval, property valuation, and/or equity determination.

In some embodiments, the alternative boarding process 200 can be automated, thereby enhancing the efficiency and accuracy of the process. The platform 110 can be configured to automatically initiate the alternative boarding process 200 upon receipt of a request for a title search 104 and/or upon detection of a change in the property data 102.

In some cases, the platform 110 can also be configured to update the starter file 114 in real-time as new property data 102 is collected and/or as changes occur in the status of the property. This can ensure that the starter file 114 remains current and accurate, thereby facilitating accurate and/or reliable property transactions.

By following processes illustrated in FIGS. 1-2, a house can be boarded onto the platform either at the time of closing and/or at a later date, allowing for flexibility in integrating the property into the home equity network and/or the associated blockchain ledger. In some embodiments, where boarding is after closing, the platform may verify the homeowner has at least a minimum retained equity in the home, as described herein.

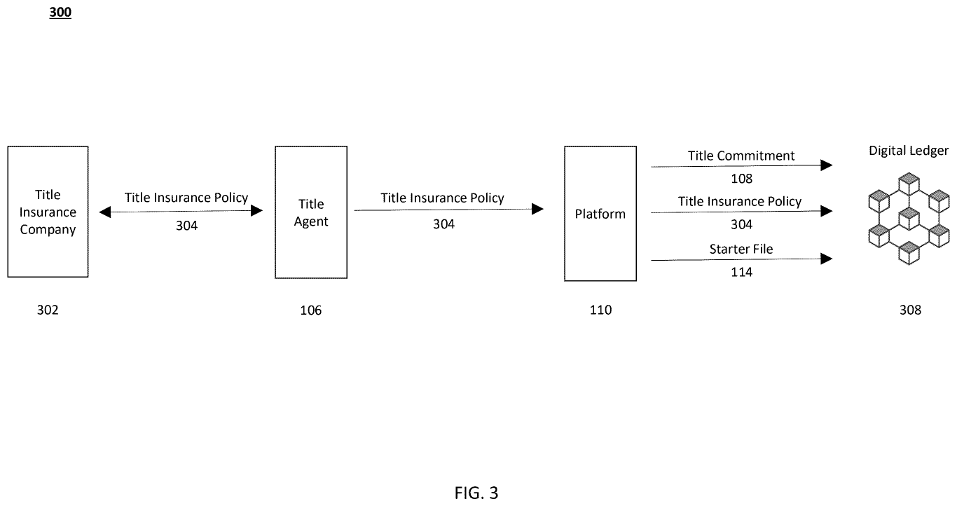

Referring now to FIG. 3, a block diagram of a title insurance policy recordation process 300 is depicted. In some aspects, a title insurance company 302 can issue a title insurance policy 304 to a title search agent 106. The title search agent 106 can then provide the title insurance policy 304 to a platform 110. In some cases, the platform 110 can record the starter file 114, title insurance policy 304, and/or the title commitment 108 in a digital ledger 308. This process can ensure that the title insurance policy 304 and/or the associated documents, such as the title commitment 108 and/or the starter file 114, are transparently and accurately recorded.

A title insurance policy can be a contract that protects real estate owners and lenders against any property loss and/or damage they might experience because of liens, encumbrances, and/or defects in the title to the property. Each title insurance policy can be subject to specific terms, conditions, and/or exclusions. The policy can cover the insured party for any covered title risk that is not excepted in the policy. The title insurance policy can cover the cost of legal defense against challenges to the title. The title insurance policy can be issued after a comprehensive title search of the property records, which can aim to identify any title defects that can be rectified before issuing the policy. Once the policy is issued, it can remain in effect for as long as the insured holds an interest in the covered property. Title insurance policies can be an integral part of the real estate transaction process, providing peace of mind and/or a safeguard against potential legal issues related to the property title. They can further be used to mitigate risk associated with credit transactions made with equity in home used as collateral.

In some aspects, the transparency and/or verifiability of a blockchain ledger can be features that distinguish it from traditional record-keeping methods. A blockchain ledger (e.g., the digital ledger 308) can be a decentralized database that maintains a continuously growing list of records, called blocks, which can be linked and/or secured using cryptography. Each block can contain a cryptographic hash of the previous block, a timestamp, and/or transaction data, making it resistant to data modification.

The inherent design of the blockchain ledger can ensure that once a transaction has been recorded, the information cannot be altered retroactively without the alteration of all subsequent blocks and/or the consensus of the network. This level of immutability provides a transparent and/or verifiable audit trail of all transactions and/or changes made to the ledger. As a result, all parties involved in the transaction can trust the accuracy and/or authenticity of the records without the need for a central authority and/or intermediary.

Moreover, the blockchain ledger can be accessible to all participants who have permission to view it, allowing for real-time verification of transactions and/or asset ownership. This transparency can not only bolsters trust among users but can also enhance the security of the system by making any attempts at fraud immediately visible to all parties. The verifiability of the blockchain ledger, therefore, can help with the system's integrity, and/or can provide a reliable and/or trustworthy foundation for managing property transactions and/or other transactions based on property equity as described in the present disclosure.

In some aspects, the title insurance policy recordation process 300 can be automated, thereby enhancing the efficiency and/or accuracy of the process. The platform 110 can be configured to automatically initiate the title insurance policy recordation process 300 upon receipt of the title insurance policy 304 from the title search agent 106.

In some cases, the platform 110 can also be configured to update the digital ledger 308 in real-time as changes occur in the status of the title insurance policy 304 and/or the title commitment 108. This can ensure that the digital ledger 308 remains current and accurate, thereby facilitating accurate and/or reliable property transactions.

In some aspects, the title insurance policy recordation process 300 can be used in conjunction with the boarding processes 100/200 described in relation to FIG. 1 and FIG. 2. This can provide a comprehensive and/or integrated solution for managing property data and/or transactions.

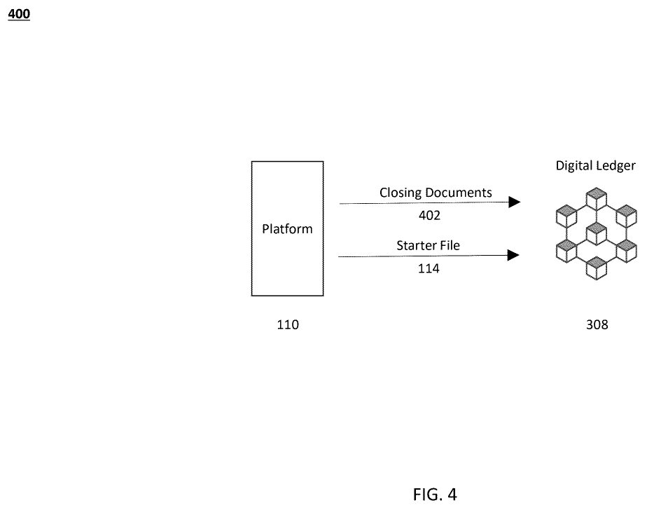

Referring now to FIG. 4, an alternative digital ledger recordation process 400 is depicted. In some aspects, the platform 110 can record the closing documents 402 and/or the starter file 114 in the digital ledger 308. For example, a homeowner can directly provide the platform 110 the closing documents 402 and/or other related documentation associated with the purchase (e.g., past or present) of a home.

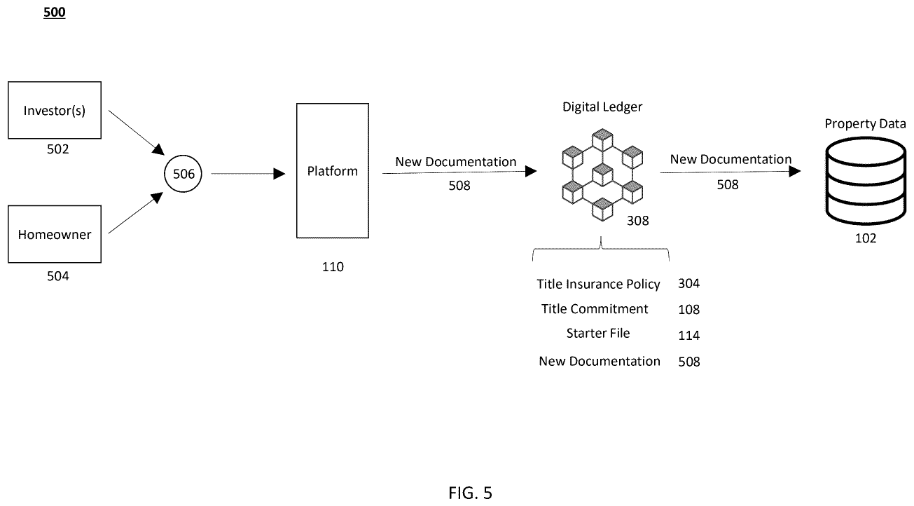

Referring now to FIG. 5, a block diagram of a transaction management system 500 is depicted. In some aspects, investors 502 and/or a homeowner 504 can perform equity sales and/or purchases 506 via a platform 110. The platform 110 can generate new documentation 508 based on the equity sales and purchases 506 and/or record them on a digital ledger 308. Property data 102 records can be updated based on the new documentation 508. In some embodiments, the transaction can be for a fractional portion of a property. The equity can be in the form of an asset token, as described herein.

In some cases, the platform 110 can be configured to facilitate the equity sales and/or purchases 506 between the investors 502 and/or the homeowner 504. This can provide a convenient and/or efficient way for the parties to transact with each other, thereby enhancing the liquidity and/or flexibility of the real estate market.

In some embodiments, the platform 110 can generate new documentation 508 based on the equity sales and/or purchases 506. This new documentation 508 can include, for example, transaction records, ownership records, and/or valuation records. The new documentation 508 can record the transaction of asset tokens. The new documentation 508 can be recorded on the digital ledger 308, and can help provide a secure and/or transparent record of the transactions.

In some aspects, public property data 102 records can be updated based on the new documentation 508.

In some cases, the tokens, which can be asset tokens and/or homeowner tokens, can be pledged as security for a bank and/or other lending institution. This can be done via a Uniform Commercial Code (UCC) filing, which can be a legal form that a creditor files to give notice that it has an interest in the personal property of a debtor. The tokens can be moved into a custodial wallet in order to perfect the security interest. This variation can provide additional security for the lending institution and/or can facilitate the approval of loans or other financial transactions.

In some embodiments, the transaction management system 500 can be used to update records boarded in reference to FIGS. 1-4.

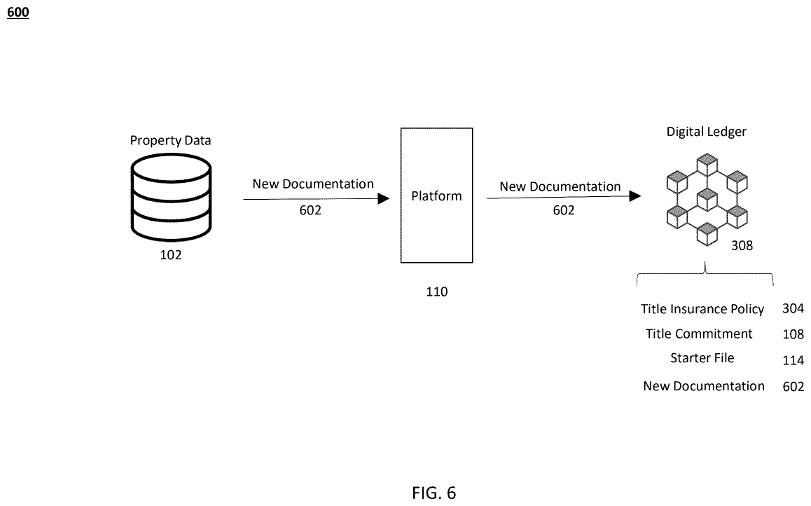

Referring now to FIG. 6, a title tracking process 600 is depicted. In some aspects, a platform 110 can monitor property data 102 for new documentation 602, such as new property records. The platform 110 can be configured to limit the monitoring of new documentation 602 to records created after the creation date of a starter file 114. This can ensure that the platform 110 is not overwhelmed with irrelevant data and/or can focus on the latest and/or relevant property records.

In some cases, the new documentation 602 can be recorded on the digital ledger 308. The digital ledger 308 can be updated in real-time as new documentation 602 is collected, ensuring that the digital ledger 308 remains current and/or accurate.

In some embodiments, the platform 110 can be configured to monitor property records associated with the real estate property on an external server. This can provide a comprehensive and/or up-to-date record of the property, which can be useful for various purposes such as transaction approval, property valuation, and/or equity determination.

In some aspects, the platform 110 can update the digital ledger 308 in real-time based on the property records. This can help the digital ledger 308 remain current and/or accurate, thereby facilitating accurate and/or reliable transactions based on said records.

In some aspects, the system can accommodate major capital improvements that homeowners may make to enhance their property value and/or equity position. The homeowner may initiate a capital improvement process by providing advance notification to the platform 110, which may include details about planned renovations, additions, and/or other substantial property enhancements. In some embodiments, the platform 110 may evaluate whether the proposed improvements qualify as major capital improvements that may affect the property's valuation and the homeowner's equity stake. In some cases, the system may require documentation such as permits, contractor agreements, and/or estimated costs to validate the scope and/or legitimacy of the proposed improvements.

The capital improvement process may include conducting property valuations both before and after the completion of the improvements to determine the actual value increase attributable to the homeowner's investment. The platform 110 may coordinate with appraisers and/or automated valuation models to establish baseline property values prior to construction and updated valuations upon completion. In some embodiments, the system may track the progress of improvements through periodic inspections and/or photo documentation to verify that work is being completed according to approved plans and jurisdictional guidelines. The digital ledger 308 may maintain a comprehensive record of all improvement activities, including permits, contractor information, progress updates, and/or final completion documentation.

Upon completion of major capital improvements, the homeowner's equity position in the property may be adjusted to reflect the increased property value attributable to their investment. The platform 110 may calculate the capital improvement value as the difference between the post-improvement and pre-improvement property valuations, with this value being credited to the homeowner's equity stake. In some cases, the system may apply depreciation schedules to the improvement value over time to account for the aging of the improvements. The updated equity calculations may be recorded on the digital ledger 308 and/or reflected in the homeowner's dashboard, affecting their ability to conduct future equity transactions and/or exercise various rights within the co-ownership structure.

The valuation process may incorporate multiple methodologies and/or data sources to provide comprehensive and/or accurate property assessments. In some aspects, the valuation may include automated valuation models (AVMs) that utilize algorithmic approaches to estimate property values based on comparable sales data, market trends, and/or property characteristics. The platform may also incorporate physical appraisals conducted by licensed professionals who perform on-site inspections and/or detailed property evaluations to determine fair market value.

In some cases, the valuation process may utilize broker price opinions (BPOs), which can provide market-based assessments from real estate professionals familiar with local market conditions and/or property values. The platform may also consider sales contracts as valuation inputs, using actual transaction data and/or agreed-upon purchase prices to inform property value determinations. Additionally, Asset Token Sales data may be incorporated into the valuation methodology, where the trading activity and/or pricing of tokens representing fractional interests in properties can provide market-driven insights into property values.

The platform may determine from time to time to include other relevant inputs in the valuation process, which can encompass various data sources such as market indices, economic indicators, neighborhood development patterns, zoning changes, and/or environmental factors that may affect property values. This flexible approach to valuation inputs can allow the system to adapt to changing market conditions and/or incorporate new data sources as they become available or relevant to property assessment accuracy.

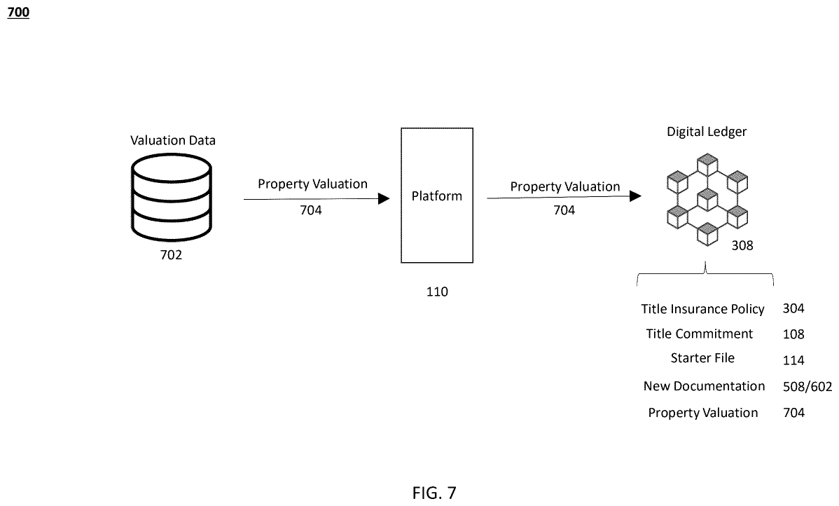

Referring now to FIG. 7, a valuation monitoring process 700 is depicted. In some aspects, a platform 110 can monitor valuation data 702 in order to track home price changes. When a change in property valuation 704 occurs, the platform 110 can update the digital ledger 308 with the new property valuation 704, thereby keeping it in sync with real-time property price movements.

Property valuations can be performed by assessing a variety of factors that contribute to the current market value of a real estate property. This process can involve a detailed analysis of comparable property sales within the same geographic area, known as “comps,” which can provide a benchmark for determining a property's fair market value. Valuators can also examine the property's location, size, condition, and/or any improvements and/or renovations that have been made. Public records, such as tax assessments, zoning status, and/or building permits, can be reviewed to gather comprehensive data about the property. In some cases, an on-site inspection can be conducted to evaluate the property's physical state and/or any features that could affect its value. Advanced valuation models can incorporate economic indicators, market trends, and/or statistical data analysis to refine the valuation further. The resulting valuation can be a synthesis of these diverse elements, and/or can provide an estimate of the property's worth in the current real estate market.

Property valuation can be performed, at least in part, by analyzing a variety of public records that reflect the current and/or historical market conditions of real estate properties. The platform 110 can access public records such as recent sales data, property tax assessments, zoning records, and/or geographic information system (GIS) data to assess the market value of a property. By comparing similar properties in the same area, known as comparables or “comps,” the platform can estimate the property's market value based on recent sale prices of these comps.

The platform 110 can also consider the property's characteristics, including size, condition, age, location, and/or any improvements and/or renovations that have been made. Public records such as building permits and/or inspection reports can provide insights into the property's condition and/or any value-adding enhancements.

In addition to static data, the platform 110 can incorporate dynamic market indicators such as trends in housing demand, economic factors, and/or changes in the local real estate market. This dynamic analysis can be useful in rapidly changing markets where property values can fluctuate frequently.

The valuation process can be automated by the platform 110, which can use algorithms and machine learning techniques to analyze large datasets from public records and/or generate accurate an up-to-date property valuations. These valuations can then be recorded on the digital ledger 308, and can thus help all participants in the blockchain network have access to the latest property valuation information. This real-time updating of property valuations can be instrumental in supporting decision-making for transactions, investments, and/or lending activities that rely on property equity.

In some cases, the platform 110, can be configured to monitor property price movements on an external server. This can provide a comprehensive and/or up-to-date record of the property prices, which can be useful for various purposes such as transaction approval, property valuation, and/or equity determination.

In some aspects, the platform 110 can update the digital ledger 308 in real-time based on the property price movements. This can help the digital ledger 308 remain current and accurate, and can facilitate accurate and/or reliable property transactions.

In addition to the methods mentioned herein, in some aspects, the platform 110 can employ an artificial intelligence (AI) model to enhance the accuracy of property valuations. The AI model can analyze captured imagery of the home, such as photographs and/or videos, to assess the property's condition, aesthetic appeal, and/or any visible improvements and/or damages. By applying machine learning algorithms, including convolutional neural networks (CNNs), the AI model can process the visual data to estimate the property's market value with a high degree of precision.

In some aspects, the property valuation can be complemented by trading data associated with asset tokens. The trading data can include transaction volumes, price fluctuations, bid-ask spreads, and/or liquidity measures. The trading data can provide real-time insights into the demand and/or liquidity of the property's fractionalized interests, which can influence the property's valuation. By integrating the AI analysis of imagery with the trading data, the platform 110 can derive a comprehensive valuation that reflects both the physical state of the property and/or the current market conditions as perceived by investors.

The combined use of AI analysis and/or trading data can help the platform 110 to dynamically adjust the property valuation on the blockchain ledger. This real-time valuation adjustment can help the ledger reflect the property's current and/or accurate equity value, which can help provide accurate decision metrics for transaction approval, investments, and/or lending activities that depend on the property's equity. The integration of AI and/or market data into the valuation process can represent a forward-thinking approach to real estate asset management, leveraging the potential of blockchain technology to help maintain an up-to-date and/or transparent ledger.

In some aspects, the platform 110 can be configured to automatically initiate the valuation monitoring process 700 upon detection of a change in property prices. This can enhance the efficiency of the process and/or reduce the chances of errors and/or omissions in the digital ledger 308.

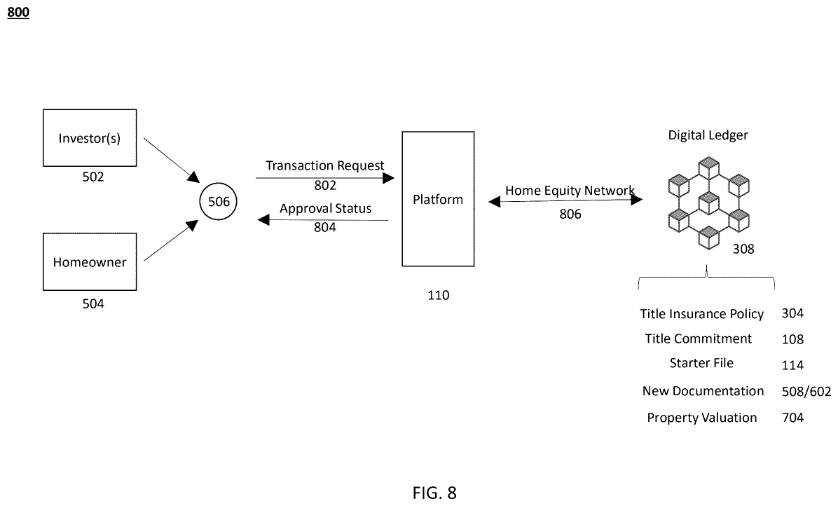

Referring now to FIG. 8, an example fractional transaction management system 800 is depicted. In some aspects, a homeowner 504 and/or investors 502 can perform a transaction request 802 for a fractional equity sale and/or purchase 506. The platform 110 can communicate with the Home Equity Network 806 to determine ownership, valuation, and/or to clear lien status in the digital ledger 308. A transaction approval status 804, such as approved or declined, can be provided in real-time.

As a result of these transactions, homeowner 504 and/or investor 502 equity can fluctuate over time for a given property. In some aspects, the platform 110 can require the homeowner 504 to maintain a threshold of unencumbered equity in the home. In other words, the homeowner 504 may be unable to perform transactions (e.g., sell or secure a loan) below a certain threshold of unencumbered equity in the home.

In some aspects, the threshold of unencumbered equity can be a percentage of the total value of the property. Alternatively, and/or additionally, the threshold of unencumbered equity can be a static value.

The Home Equity Network 806 can provide a reliable real-time determination of unencumbered equity a homeowner 504 and/or investor 502 has in a property.

In some aspects, the tenancy in common (TIC) interest for each party (e.g., the homeowner 504 and/or investor(s) 502) may change over time as a result of various transactions facilitated by the platform 110 as described herein. As these transactions occur, the homeowner's 504 TIC interest in the property can change proportionally to the amount of equity acquired and/or lost.

For example, if the homeowner 504 purchases additional equity (e.g., by purchasing additional TIC interests, purchasing additional asset tokens, and/or being rewarded additional equity using rewards from a credit card network), their TIC interest in the property can increase accordingly. Similarly, if an investor 502 sells their asset tokens back to the homeowner, their TIC interest can decrease and the TIC interest of the purchaser can increase.

The Home Equity Network 806, in conjunction with the platform 110, can ensure that all such changes in TIC interests are accurately reflected and recorded on the digital ledger 308. The ledger can provide a transparent and immutable record of the distribution of TIC interests among the parties involved.

The dynamic nature of the blockchain ledger allows for real-time updates to TIC interests and property valuations, ensuring that all parties have access to the current state of their investments and can make informed decisions regarding their real estate transactions. This system provides a robust framework for managing the complexities of fractional property ownership and the fluidity of equity transactions.

In some cases, the homeowner 504 can own the occupancy token. This variation can provide the homeowner 504 with the right to occupy the property, while the investors 502 and/or the homeowner 504 can own asset tokens, which can represent fractional ownership interests in the property. Alternatively, in some aspects of the disclosure, only inventors 502 may own asset tokens, while homeowners 502 hold TIC interests. This arrangement can provide a flexible and/or efficient way for homeowners to leverage their home equity for various financial transactions.

In some embodiments, the platform 110 can be configured to facilitate the transaction request 802 and/or to communicate with the Home Equity Network 806. This can involve determining the amount and/or value of unencumbered equity that the homeowner 504 holds and/or can help confirm the assets of the homeowner 504. The platform 110 can use traditional security instruments, such as a mortgage, to secure the loan against the homeowner's TIC interest. Alternatively, the loan could be unsecured, with the lender simply using the Home Equity Network 806 to confirm the assets of the homeowner 504.

In some aspects, the platform 110 can be configured to provide a transaction approval status 804 in real-time. This can enhance the efficiency of the fractional transaction management system 800 and/or can provide immediate feedback to the homeowner 504 and/or the investors 502. The real-time transaction approval status 804 can be based on the current state of the digital ledger 308, which can be updated in real-time as changes occur in the status of the property and/or the equity of the homeowner 504.

In some cases, the platform 110 can also be configured to update the digital ledger 308 in real-time based on the transaction request 802 and/or the transaction approval status 804. This can ensure that the digital ledger 308 remains current and accurate, thereby facilitating accurate and/or reliable property transactions.

In some cases, economic interests in the home, which can be in the form of asset tokens and/or HPI tokens, can be pledged as security for a line of credit (e.g., by a card issuer). This can be done via a UCC filing, which can be a legal form that a creditor files to give notice that it has an interest in the personal property of a debtor. In some embodiment, asset tokens can be moved into a custodial wallet in order to perfect the security interest of the card issuers. Alternatively, the digital ledger 308 can be relied upon as a verifiable record that the funds are available. This variation can provide additional security for the card issuers and can facilitate the approval of transactions.

In some aspects, investors holding HPI tokens and/or LAT tokens can pledge these digital assets as security for a line of credit from financial institutions. The pledging process may involve transferring the HPI tokens and/or LAT tokens to a custodial wallet controlled by the lending institution, which may serve to perfect the security interest in accordance with applicable regulations. The lender can rely on the digital ledger 308 to verify the existence, authenticity, and/or value of the pledged tokens, as the blockchain-based record can provide a transparent and/or immutable verification of token ownership and/or current market value. In some cases, a UCC filing may be executed to provide legal notice of the lender's security interest in the pledged HPI and/or LAT tokens. The value of the pledged tokens may be determined based on their market value and/or book value as recorded on the platform 110, with the credit line amount potentially fluctuating based on changes in token valuations. This arrangement may allow investors to access liquidity while maintaining their exposure to real estate appreciation through their token holdings, and/or can provide lenders with digital collateral that can be easily monitored and valued through the blockchain infrastructure.

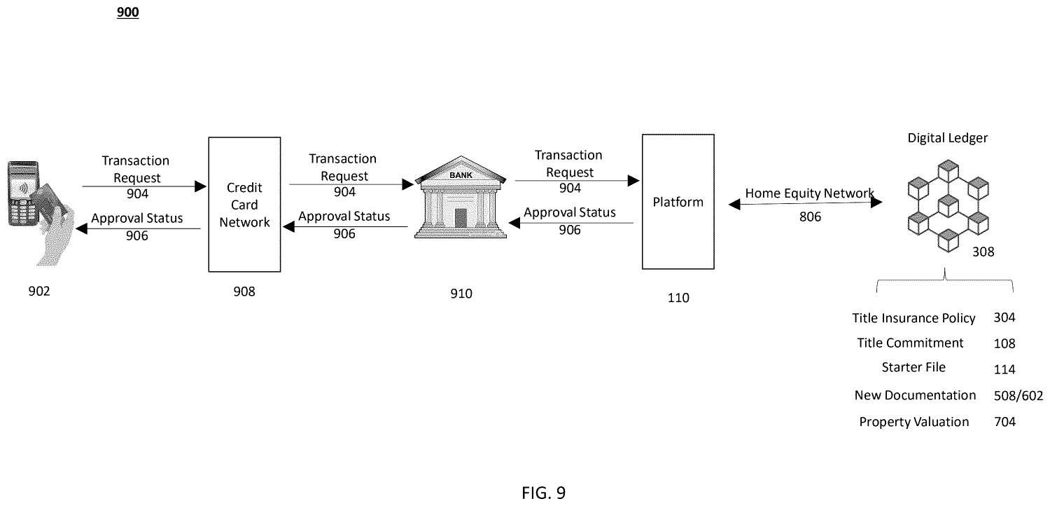

Referring now to FIG. 9, a block diagram of a transaction approval system 900 is depicted. In some aspects, a user transaction device 902 can send a transaction request 904 to a credit card network 908, which can seek authorization from an issuing bank 910. The issuing bank 910 can then communicate with a platform 110 to verify security for the credit. The platform 110 can communicate via a home equity network 806 to the digital ledger 308 to determine if there is sufficient home equity to approve the transaction.

The equity can be determined by analyzing the digital ledger 308, which can contain records such as a title insurance policy 304, a title commitment 108, a starter file 114, documentation relating to changes in ownership status 508/602, and/or property valuation 704. In some cases, the transaction approval status 906 can be communicated back to the user transaction device 902 through the credit card network 908, and/or can help complete the cycle of the transaction approval process.

In some embodiments, the platform 110 can be configured to receive a payment notification associated with the transaction. This can provide real-time information about the status of the transaction, thereby facilitating accurate and/or timely updates of the digital ledger 308. In some cases, the platform 110 can be configured to update the digital ledger 308 based on the payment notification. This can help ensure that the digital ledger 308 remains current and/or accurate, thereby facilitating accurate and/or reliable property transactions.

In some aspects, the platform 110 can be configured to acquire, on behalf of the user, a portion of equity (e.g., in TIC interests) based on a reward system associated with the credit card network 908 and/or the issuing bank 910. In some cases, interchange fees can be utilized to provide rewards. This variation can provide a flexible and/or efficient way for homeowners to leverage their home equity for various financial transactions.

In some cases, the platform 110 can be configured to receive a payment delinquency notification associated with the transaction. This can provide real-time information about any payment issues and/or delinquencies, thereby facilitating prompt and/or appropriate action. In some embodiments, the platform 110 can be configured to divest, on behalf of the user, a portion of the plurality of the equity (e.g., in asset tokens) in compensation for the amount of the transaction. This can provide a flexible and/or efficient way for users to manage their financial obligations.

In some aspects, a homeowner can make a request to sell a portion of the equity. The platform 110, which can also be referred to as the home equity network 806, can be used to ensure that there is sufficient unencumbered equity to proceed with the transaction. This can provide a convenient and/or efficient way for homeowners to leverage their home equity for various financial transactions.

Minimum retained equity (e.g., expressed in a percentage form) can be the equity that a Homeowner is required to retain based on current underwriting criteria imposed by the platform 110, as can be amended from time to time. This can be a dynamic number which changes based on the value of the House occupied by the Homeowner and/or Homeowner profiles at a given moment in time and/or can be used to manage default risks. The amount of Minimum Retained Equity can be determined by a proprietary algorithm, which can use the Homeowner's credit score, front and/or back-end debt to income ratios, a Contingency Fund composition, and/or Homeowner and/or property specific data as inputs at a given moment in time. The Minimum Retained Equity can also be used to calculate the minimum purchase price required to be paid by the Homeowner for their TIC Interests in the House when the House is initially boarded to the platform 110.

In some embodiments, the platform 110 can be configured to enforce a minimum retained equity threshold for the homeowner 504. This minimum retained equity represents the smallest percentage of equity that the homeowner 504 is obliged to retain in their property to ensure financial stability and/or compliance with regulatory requirements. The platform 110 can calculate the unencumbered equity by subtracting any existing liens or encumbrances from the current property valuation 704 as recorded in the digital ledger 308.

Before proceeding with a transaction request 802, the platform 110 can verify that the homeowner 504 maintains the minimum retained equity after the transaction. If the transaction would cause the homeowner's equity to fall below this threshold, the platform 110 can decline the transaction approval status 804 and/or require additional steps to be taken to maintain the minimum retained equity. This safeguard can help protect both the homeowner 504 and/or the integrity of the fractionalized risk pool by ensuring that the homeowner 504 does not over-leverage their property.

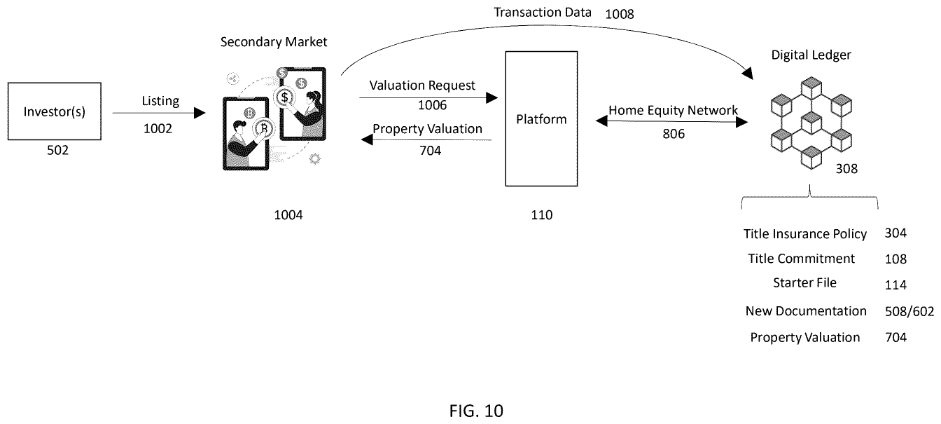

Referring now to FIG. 10, a block diagram of an investor transaction system 1000 for managing fractional real estate transactions is depicted. In some aspects, investors 502 can initiate a listing process 100 which can interact with a secondary market 1004. The secondary market 1004 can send a valuation request 1006 to a platform 110. The platform 110 can communicate with a home equity network 806 to determine the valuation using a digital ledger 308. The platform 110 can provide a property valuation 704 to the secondary market 1004.

In some cases, the platform 110, which can also be referred to as the home equity network 806, can be configured to receive a request for the property valuation 704 from the secondary market 1004. The secondary market 1004 can be configured for updating the blockchain ledger, and/or digital ledger 308, in response to a trade comprising a portion of the plurality of asset tokens and/or HPI tokens. This variation can provide a flexible and/or efficient way for investors 502 to leverage their investments for various financial transactions.

The secondary market 1004 can be a digital asset trading market, where participants can engage in the buying and/or selling of digital assets, such as the asset tokens associated with fractional real estate ownership. This market can enable investors to liquidate and/or acquire stakes in property quickly and/or efficiently, providing a platform for the exchange of digital representations of real property equity. The secondary market 1004 can interface with the platform 110 to obtain accurate and/or up-to-date property valuations, and can help trades be conducted based on the latest market data as reflected in the digital ledger 308. This integration with the blockchain ledger can facilitate a transparent, secure, and/or streamlined trading experience for all parties involved. The secondary market 1004 can or can not be directly associated with the platform 110.

In some embodiments, the platform 110 can be configured to communicate with the home equity network 806 to determine the valuation using the digital ledger 308. This can involve analyzing the digital ledger 308, which can contain records such as a title insurance policy, a title commitment, a starter file, new documentation, and/or a property valuation. This can help the valuation be based on the latest and/or accurate property data, thereby facilitating accurate and/or reliable property transactions.

### EXAMPLES

The following examples illustrate various use cases for the disclosed system and method for managing real estate property transactions using blockchain technology. Note that these are example cases only, and that steps in the example can be done in another order, and that not all steps or elements in the example may be necessary.

### Example 1—Credit/Debit Card Transaction Approval

A homeowner who is a participant in the Quarter Home Equity Network can be issued a credit card by an issuing bank. The credit limit for specific transactions can be determined by checking the amount and/or value of unencumbered equity that the homeowner possesses at the time of the card's use. The platform 110 can leverage the blockchain ledger to provide real-time verification of the homeowner's equity, helping to provide sufficient collateral for the credit transaction. Additionally, interchange fees from the credit card network can be utilized to provide rewards, which could be used to purchase additional fractional interests in the home, further integrating the homeowner's financial activities with their real estate assets.

### Example 2—TradFi Lending

A traditional finance (TradFi) lender approves a loan to a homeowner based on the amount and/or value of unencumbered equity the homeowner holds. The loan can be secured against the homeowner's tenancy in common (TIC) interest using traditional security instruments, such as a mortgage, or it could be unsecured, with the lender simply using the Home Equity Network 806 to confirm the homeowner's assets. The platform 110 can help facilitate this process by providing accurate and/or up-to-date information on the homeowner's equity status.

### Example 3—Equity Sale Via Platform

A homeowner can request to sell a portion of their equity through the platform 110. The platform 110, as part of the Home Equity Network 806, can help determine that there is sufficient unencumbered equity available to proceed with the transaction. This process can be streamlined by the real-time data provided by the blockchain ledger, which can reflect the current equity status and/or valuation of the property.

### Example 4—DeFi Lending

A homeowner or inventor opts to convert a portion of their equity into tokens (e.g., asset tokens and/or HPI tokens), which can be used in decentralized finance (DeFi) lending activities such as swapping for stable coins or staking. The platform 110 can confirm the amount and/or value of unencumbered equity and/or enables the conversion of that equity into tokens. These tokens, which can be asset tokens and/or a new form of homeowner token, can then be available for use in the DeFi ecosystem.

### Example 5—TradFi Lending Secured by Tokens

In this scenario, a homeowner can convert a portion of their equity into tokens, which can then pledged as security for a bank and/or other lending institution. The tokens can be moved into a custodial wallet to perfect the security interest, with the transaction facilitated by a UCC filing. The platform 110 can help provide an accurate representation of the homeowner's unencumbered equity and/or the proper recording of the security interest on the blockchain ledger.

### Examples 6—Debit/Credit Cards Secured by Tokens

A homeowner can convert a portion of their equity into tokens, which can then be pledged as security for a card issuer. The tokens can be moved into a custodial wallet to perfect the security interest, and/or the digital ledger 308 can serve as a verifiable record of available funds. Interchange fees from the card issuer could be utilized to provide rewards, which could be used to purchase additional fractional interests in the home, integrating the homeowner's credit transactions with their real estate investments.

These examples demonstrate some versatility and/or efficiency features of the disclosed system and method in facilitating various financial transactions related to real estate property, leveraging the transparency and/or security of blockchain technology.

### Example Computer System

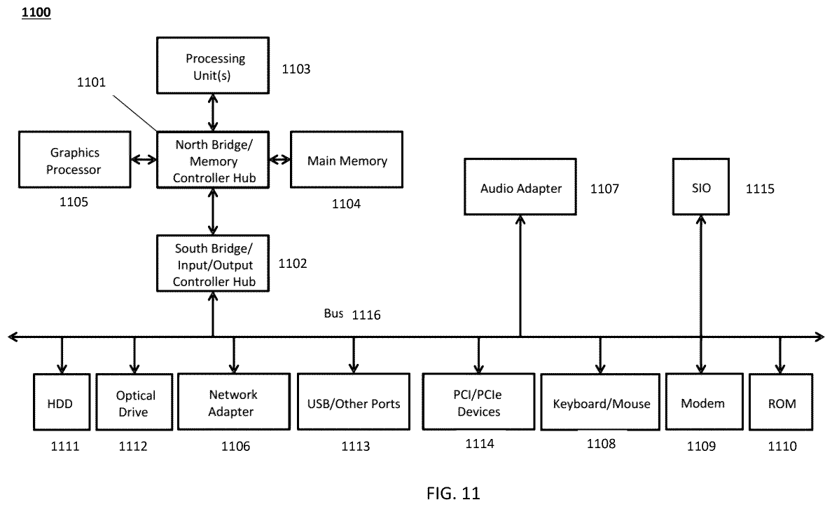

FIG. 11 illustrates a block diagram of a data processing system 1100 in which embodiments are implemented. The data processing system 1100 is an example of a computer, such as a server or client, in which computer usable code or instructions implementing the process for illustrative embodiments of the present invention are located. In some embodiments, the data processing system 1100 can be a server computing device. For example, the data processing system 1100 may be implemented in a server or another similar computing device operably connected to a surgical system 100 as described above. The data processing system 1100 may be configured to, for example, transmit and receive information related to a patient and/or a related surgical plan with the surgical system 100.

In the depicted example, the data processing system 1100 may employ a hub architecture including a north bridge and memory controller hub (NB/MCH) 1101 and south bridge and input/output (I/O) controller hub (SB/ICH) 1102. A processing unit 1103, a main memory 1104, and a graphics processor 1105 may be connected to the NB/MCH 1101. The graphics processor 1105 may be connected to the NB/MCH 1101 through, for example, an accelerated graphics port (AGP).

In the depicted example, a network adapter 1106 connects to the SB/ICH 1102. An audio adapter 1107, a keyboard and mouse adapter 1108, a modem 1109, a read only memory (ROM) 1110, a hard disk drive (HDD) 1111, an optical drive (e.g., CD or DVD) 1112, a universal serial bus (USB) ports and other communication ports 1113, and PCI/PCIe devices 1114 may connect to the SB/ICH 1102 through a bus system 1116. The PCI/PCIe devices 1114 may include Ethernet adapters, add-in cards, and/or PC cards for notebook computers. The ROM 1110 may be, for example, a flash basic input/output system (BIOS). The HDD 1111 and the optical drive 1112 may use an integrated drive electronics (IDE) or serial advanced technology attachment (SATA) interface. A super I/O (SIO) device 1115 may be connected to the SB/ICH 1102.

An operating system may run on the processing unit 1103. The operating system may coordinate and provide control of various components within the data processing system 1100. As a client, the operating system may be a commercially available operating system. An object-oriented programming system, such as the Java™ programming system, may run in conjunction with the operating system and provide calls to the operating system from the object-oriented programs or applications executing on the data processing system 1100. As a server, the data processing system 1100 may be an IBM® eServer™ System® running the Advanced Interactive Executive operating system or the Linux operating system. The data processing system 1100 may be a symmetric multiprocessor (SMP) system that includes a plurality of processors in the processing unit 1103. Alternatively, a single processor system may be employed.

Instructions for the operating system, the object-oriented programming system, and applications or programs are located on storage devices, such as the HDD 1111, and are loaded into the main memory 1104 for execution by the processing unit 1103. The processes for embodiments described herein may be performed by the processing unit 1103 using computer usable program code, which can be located in a memory such as, for example, main memory 1104, ROM 1110, or in one or more peripheral devices.

A bus system 1116 may comprise one or more busses. The bus system 1116 may be implemented using any type of communication fabric or architecture that provides for a transfer of data between different components or devices attached to the fabric or architecture. A communication unit such as the modem 1109 or the network adapter 1106 may include one or more devices that can be used to transmit and receive data.

Those of ordinary skill in the art will appreciate that the hardware depicted in FIG. 11 may vary depending on the implementation. Other internal hardware or peripheral devices, such as flash memory, equivalent non-volatile memory, or optical disk drives may be used in addition to or in place of the hardware depicted. Moreover, the data processing system 1100 can take the form of any of a number of different data processing systems, including but not limited to, client computing devices, server computing devices, tablet computers, laptop computers, telephone or other communication devices, personal digital assistants, and the like. Essentially, data processing system 1100 can be any known or later developed data processing system without architectural limitation.

Computer program medium and computer usable medium may refer to memories, such as the main memory and secondary memory, which may be memory semiconductors (e.g., DRAMs, etc.). These computer program products may be means for providing software to the computer system. Computer programs (e.g., computer control logic) may be stored in the main memory and/or the secondary memory. Computer programs may also be received via the communications interface. Such computer programs, when executed, may enable computer system to implement the present methods as discussed herein. In particular, the computer programs, when executed, may enable processor device to implement the methods, as discussed herein. Accordingly, such computer programs may represent controllers of the computer system. Where the present disclosure is implemented using software, the software may be stored in a computer program product and loaded into the computer system using the removable storage drive, interface, and hard disk drive, or communications interface.

The processor device may comprise one or more modules or engines configured to perform the functions of the computer system. Each of the modules or engines may be implemented using hardware and, in some instances, may also utilize software, such as corresponding to program code and/or programs stored in the main memory or secondary memory. In such instances, program code may be compiled by the processor device (e.g., by a compiling module or engine) prior to execution by the hardware of the computer system. For example, the program code may be source code written in a programming language that is translated into a lower-level language, such as assembly language or machine code, for execution by the processor device and/or any additional hardware components of the computer system. The process of compiling may include the use of lexical analysis, preprocessing, parsing, semantic analysis, syntax-directed translation, code generation, code optimization, and any other techniques that may be suitable for translation of program code into a lower-level language suitable for controlling the computer system to perform the functions disclosed herein. It will be apparent to persons having skill in the relevant art that such processes result in the computer system being a specially configured computer system uniquely programmed to perform the functions discussed above.

Techniques consistent with the present disclosure provide, among other features, systems and methods for performing transactions via asset tokens and a blockchain based smart contract.

### Additional Embodiments

Additional embodiments can comprise any combination of the following systems and methods:

A system comprising a processor configured for creating a fractionalized risk pool for a real estate property, the fractionalized risk pool comprising a plurality of asset tokens and an occupancy token, the plurality of asset tokens and the occupancy token issued using a blockchain ledger; receiving, over a network, title information associated with the real estate property; updating the blockchain ledger with information comprising the title information, a timestamp, and a property valuation; receiving a transaction, via at least one of a credit card network or an issuing bank, comprising an amount and a user, determining a real-time equity of the user based on the blockchain ledger; determining an approval status of the transaction based on the real-time equity of the user; transmitting the approval status to the at least one of the credit card network or the issuing bank; and updating the blockchain ledger based on the approval status. The system wherein the processor is further configured for receiving a payment notification associated with the transaction. The system, wherein the processor is further configured for updating the blockchain ledger based on the payment notification. The system, wherein the processor is further configured for acquiring, on behalf of the user, a portion of the plurality of asset tokens based on a reward system associated with the at least one of the credit card network and/or the issuing bank. The system, wherein the processor is further configured for receiving a payment delinquency notification associated with the transaction. The system, wherein the processor is further configured for divesting, on behalf of the user, a portion of the plurality of asset tokens in compensation for the amount of the transaction. The system, wherein the title information comprises a title commitment and a title insurance policy. The system, wherein the processor is further configured for: monitoring property price movements on an external server; and updating, in real-time, the property valuation based on the property price movement. The system, wherein the processor is further configured for: monitoring property records associated with the real estate property on an external server; and updating, in real-time, the block ledger based on the property records, wherein monitoring the property records is limited to records created after the timestamp. The system, wherein the user owns the occupancy token. The system, wherein the processor is further configured for receiving a request for the property valuation from a secondary market, wherein the secondary market is configured for updating the blockchain ledger in response to a trade comprising a portion of the plurality of asset tokens.

A method for managing real estate property transactions, the method comprising: creating, by a processor, a fractionalized risk pool for a real estate property, the fractionalized risk pool comprising a plurality of asset tokens and an occupancy token, the plurality of asset tokens and the occupancy token issued using a blockchain ledger; receiving, by the processor over a network, title information associated with the real estate property; updating, by the processor, the blockchain ledger with information comprising the title information, a timestamp, and a property valuation; receiving, by the processor via at least one of a credit card network or an issuing bank, a transaction comprising an amount and a user; determining, by the processor, a real-time equity of the user based on the blockchain ledger; determining, by the processor, an approval status of the transaction based on the real-time equity of the user; transmitting, by the processor, the approval status to the at least one of the credit card network or the issuing bank; and updating, by the processor, the blockchain ledger based on the approval status. The method, further comprising receiving, by the processor, a payment notification associated with the transaction. The method, further comprising updating, by the processor, the blockchain ledger based on the payment notification. The method, further comprising acquiring, by the processor on behalf of the user, a portion of the plurality of asset tokens based on a reward system associated with the at least one of the credit card network and/or the issuing bank. The method, further comprising receiving, by the processor, a payment delinquency notification associated with the transaction. The method, further comprising divesting, by the processor on behalf of the user, a portion of the plurality of asset tokens in compensation for the amount of the transaction. The method, wherein the title information comprises a title commitment and a title insurance policy. The method, further comprising: monitoring, by the processor, property price movements on an external server; and updating, by the processor in real-time, the property valuation based on the property price movement. The method, further comprising: monitoring, by the processor, property records associated with the real estate property on an external server; and updating, by the processor in real-time, the blockchain ledger based on the property records, wherein monitoring the property records is limited to records created after the timestamp.

### CONCLUSION

While various exemplary embodiments of the disclosed system and method have been described above it should be understood that they have been presented for purposes of example only, not limitations. It is not exhaustive and does not limit the disclosure to the precise form disclosed. Modifications and variations are possible in accordance with the above teachings or may be acquired from practicing of the disclosure, without departing from the breadth or scope.

While the disclosure has been described with reference to numerous specific details, one of ordinary skill in the art will recognize that the disclosure can be embodied in other specific forms without departing from the spirit of the disclosure. In addition, a number of the figures illustrate processes. The specific operations of these processes may not be performed in the exact order shown and described. The specific operations may not be performed in one continuous series of operations, and different specific operations may be performed in different embodiments. Thus, one of ordinary skill in the art would understand that the invention is not to be limited by the foregoing illustrative details, but rather is to be defined by the appended claims.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. Thus, the present embodiments should not be limited by any of the above-described embodiments.

In addition, it should be understood that any figures which highlight the functionality and advantages are presented for example purposes only. The disclosed methodology and system are each sufficiently flexible and configurable such that they may be utilized in ways other than that shown.

Further, the purpose of any Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. An Abstract of the Disclosure is not intended to be limiting as to the scope of the present invention in any way.

Although the term “at least one” may often be used in the specification, claims and drawings, the terms “a”, “an”, “the”, “said”, etc. also signify “at least one” or “the at least one” in the specification, claims and drawings.

Additionally, the terms “including”, “comprising” or similar terms in the specification, claims and drawings should be interpreted as meaning “including, but not limited to.”

Finally, it is the applicant's intent that only claims that include the express language “means for” or “step for” be interpreted under 35 U.S.C. 212, paragraph 6. Claims that do not expressly include the phrase “means for” or “step for” are not to be interpreted under 35 U.S.C. 212, paragraph 6.

What is claimed:

1. A system comprising:
a processor configured for:
creating a fractionalized risk pool for a real estate property, the fractionalized risk pool comprising a plurality of asset tokens and an occupancy token, the plurality of asset tokens and the occupancy token issued using a blockchain ledger;
receiving, over a network, title information associated with the real estate property;
updating the blockchain ledger with information comprising the title information, a timestamp, and a property valuation:
receiving a transaction, via at least one of a credit card network or an issuing bank, comprising an amount and a user;
determining a real-time equity of the user based on the blockchain ledger;
determining an approval status of the transaction based on the real-time equity of the user;
transmitting the approval status to the at least one of the credit card network or the issuing bank; and
updating the blockchain ledger based on the approval status.
